(19) United States
(12) Patent Application Publication
(10) Pub. No.: US 2013/0081488 A1
(43) Pub. Date: Apr. 4, 2013

(54) POP-UP DEVICE FOR VEHICLE

(71) Applicant: Se Min OH, Seongnam (KR)

(72) Inventor: Se Min OH, Seongnam (KR)

(73) Assignees: Kia Motors Corporation, Seoul (KR); Hyundai Motor Company, Seoul (KR)

(21) Appl. No.: 13/323,606

(22) Filed: Dec. 12, 2011

(30) Foreign Application Priority Data
Sep. 29, 2011 (KR) 10-2011-0099108

(51) Int. Cl. F16H 25/12

(52) U.S. Cl. 74/89.14

(57) ABSTRACT

A pop-up device for a vehicle is provided, which includes a case, a pop-up structure inserted into an upper portion of the case, and a driving structure provided inside the case to make the pop-up structure ascend out of the case or descend into the case. More specifically, the driving structure includes a motor, a screw shaft provided in upward and downward directions in the case and has a spiral groove formed along an outer periphery thereof to be rotated through driving of the motor, and a plate on which the pop-up structure is mounted. The plate is movably coupled to the spiral groove formed on the screw shaft in the upward and downward directions to make the pop-up structure ascend or descend when the screw shaft is rotated.

### CROSS-REFERENCE TO RELATED APPLICATION

This application is based on and claims priority from Korean Patent Application No. 10-2011-0099108, filed on Sep. 29, 2011 in the Korean Intellectual Property Office, the disclosure of which is incorporated herein in its entirety by reference.

### BACKGROUND OF THE INVENTION

1. Field of the Invention

The present invention relates to a pop-up device for a vehicle, and more particularly, to a pop-up device for a vehicle, which can pop up a tweeter speaker or a portable device.

2. Description of the Prior Art

Typically, vehicles are provided with an audio device (e.g., a speaker) that outputs sound so that passengers can listen to music from an audio device. Vehicles also typically include some sort of compartment for holding for example a portable phone and/or a portable device. Speakers are an important component which is directly related to the performance of the sound system. In order to output the best possible sound performance, different kinds of speakers are need. Typically, a sounds system includes a woofer which outputs a low to mid-frequency range and a tweeter speaker that outputs a high-frequency range. In a conventional architecture, tweeter speakers are installed within an inner cover or molding of a side mirror provided on each of the front doors of the vehicle so that its output direction is toward the center of a driver's seat and a passenger's seat.

However, since the tweeter speakers permanently installed in a fixed location within the vehicle and the sound is output only in an initially designed direction. Thus, it is not possible to provide an optimum sound quality depending on the position of a main listener.

Furthermore, the compartments are often provided between the driver's seat and the passenger's seat which open upwardly. Within this compartment, devices such as portable phones and other electronic devices can be stored. However, because these compartments are so close to the shifter, these devices stored in the compartment may interfere with the driver's ability to shift or divert the driver's eyes from the road.

### SUMMARY OF THE INVENTION

Accordingly, the present invention has been made to solve the above-mentioned problems.

More specifically, a pop-up device for a vehicle is provided which includes a pop-up structure configured to accommodate a tweeter speaker or a portable device. The tweeter speaker is configured to pop up or ascend from a vehicle panel, to enable a driver or a passenger to optimally receive sound regardless of his/her location in the vehicle. Advantageously, however, the pop device can hide, e.g., a speaker, a switch, or a portable phone when the device is recessed or “popped-down” into a dash or console to increase the quality level and the merchantability thereof.

In one aspect of the present invention, there is provided a pop-up device for a vehicle, which includes a case; a pop-up structure inserted into an upper portion of the case; and a driving structure provided inside the case to make the pop-up structure ascend out of the case or descend into the case, wherein the driving structure includes a motor, a screw shaft provided in upward and downward directions in the case and having a spiral groove formed along an outer periphery thereof to be rotated via driving of the motor, and a moving plate on which the pop-up structure is mounted. The moving plate is movably coupled to the spiral groove formed on the screw shaft in the upward and downward directions to make the pop-up structure ascend or descend when the screw shaft is rotated.

As described above, according to the present invention, the pop-up device may be operationally moveable by a pulley and a timing belt and the tweeter speaker or a compartment holder provided on the pop-up device can ascend or descend. Advantageously, an optimum sound quality can be provided regardless of the passenger's location in the vehicle, or the portable phone or the portable device that is mounted within the compartment holder can be prevented from interfering with the driver's driving operation. Further, since no gears are used, noise is minimized, and the device is miniaturized to reduce the manufacturing cost.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a pop-up tweeter speaker device according to an exemplary embodiment of the present invention;

FIG. 2 is a front view illustrating a pop-up tweeter speaker device according to an exemplary embodiment of the present invention;

FIG. 3 is a front perspective view illustrating a driving structure according to an exemplary embodiment of the present invention;

FIG. 4 is a bottom perspective view illustrating a driving structure according to an exemplary embodiment of the present invention; and

FIG. 5 is a perspective view illustrating a coupling structure of a moving plate and a screw shaft according to an embodiment of the present invention.

### DETAILED DESCRIPTION

It is understood that the term “vehicle” or “vehicular” or other similar term as used herein is inclusive of all electrically operated vehicles including fuel cell and hybrid vehicles and any configuration thereof in general, such as passenger automobiles including sports utility vehicles (SUV), buses, trucks, various commercial vehicles, watercraft including a variety of boats and ships, aircraft, and the like. Further, this invention can also be modified to operate in fuel-computation vehicles as well. However, the examples below will be described with reference to an electric vehicle utilizing a battery as its main source of power.

A pop-up device for a vehicle according to an exemplary embodiment of the present invention includes a case; a pop-up structure inserted into an upper portion of the case; and a driving structure provided inside the case to provide a driving force to the pop-up structure and ascend the pop-up structure out of the case or descend the pop-up structure into the case. More specifically, the driving structure includes a motor, a screw shaft provided in upward and downward directions in the case and having a spiral groove formed along an outer periphery thereof to be rotated through driving of the motor, and a moving plate on which the pop-up structure is mounted. The moving plate is movably coupled to the spiral groove formed on the screw shaft in the upward and downward directions to make the pop-up structure ascend or descend when the screw shaft is rotated. A timing gear mounted on the motor and a timing gear mounted on the screw shaft may be connected together by a timing belt to transfer power.

In the case, a guide bar for guiding the moving plate may be provided so that the moving plate is not rotated along the spiral groove, but performs a rectilinear movement in upward and downward directions. Additionally, the case may be inserted and mounted into an inner panel within the interior compartment of the vehicle. Furthermore, a base plate for mounting the motor and the screw shaft may be provided inside the case.

A cover portion having a forming shape may be formed and configured to be hooked and fixed onto an upper portion of the case on an upper end portion of the pop-up structure. A pop-up switch configured to ascend or descend the pop-up structure through the driving structure may be mounted on one side of the cover structure.

The driving structure may be provided with a stop switch that is pressed when the moving plate is completely descended to stop the rotation of the motor. The pop-up structure may be provided with a coupling holder for coupling the tweeter speaker thereto or a coupling holder for coupling a portable phone or a portable device thereto. The moving plate may be provided with a coupling protrusion that is formed thereon and is inserted into the spiral groove of the screw shaft to ascend or descend along the spiral groove.

Hereinafter, an exemplary embodiment of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto. In the entire description of the present invention, the same drawing reference numerals are used for the same elements across various figures.

A pop-up device for a vehicle according to an exemplary embodiment of the present invention is structured so that a pop-up portion that is driven by a motor is connected to a timing gear and a timing belt to transfer power thereto so that the pop up device is ascended and descended into, e.g., a dash or console of a vehicle.

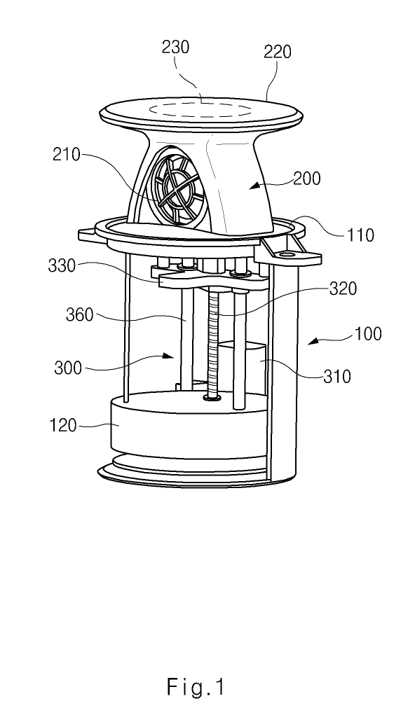

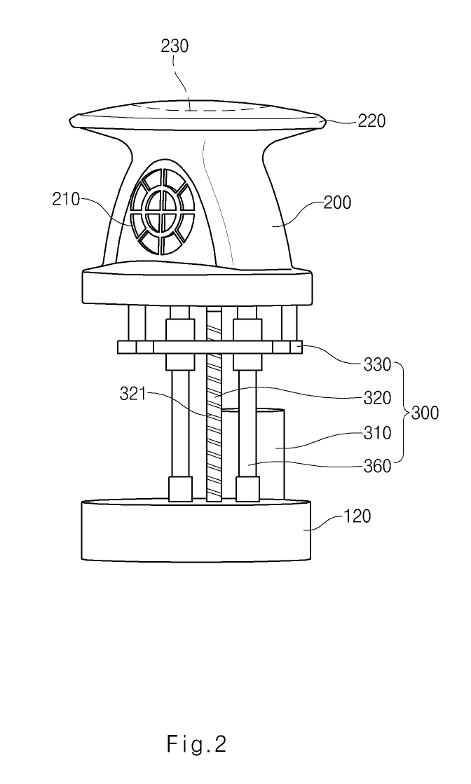

As illustrated in FIGS. 1 and 2, the pop-up device for a vehicle according to an embodiment of the present invention includes a case 100, a pop-up structure 200 inserted into an upper portion of the case 100, and a driving structure 300 configured to ascend and descend the pop-up structure 200 in and out of the case 100. In some embodiments of the present invention, the case 100 is in a cylindrical shape, and is inserted and mounted onto the inside of a panel (not illustrated) such as a dash board, a door, and/or a tray.

An insertion aperture/bore 110 for inserting the pop-up structure 200 therein is formed on an upper portion of the case 100, and a base plate 120 for mounting the driving structure 300 thereon is provided in the case 100. The pop-up structure 200 is movably inserted into the insertion aperture 110 of the case 100 in the upward and downward directions. A coupling holder 210, to which a tweeter speaker or a portable device such as a portable phone is coupled, is formed on one side of the pop-up structure 200. That is, a tweeter speaker or a portable device can be coupled to an adapter or a connector that is formed on the coupling holder 210 of the pop-up structure 200.

When a tweeter speaker is coupled to the coupling holder 210 of the pop-up structure 200, the pop-up device can be used as a tweeter speaker pop-up device. If, however, a portable device is coupled to the coupling holder 210 of the pop-up structure 200, the pop-up device can be used as a portable device pop-up device. In the illustrative embodiment, however, of the present invention, a tweeter speaker pop-up device will be described as an example.

On an upper end portion of the pop-up structure 200, a cover 220 in the form of, e.g., a disk, is formed to be hooked and supported onto an upper end of the insertion aperture 110. That is, the cover 220 is in the same shape as the insertion aperture 100. The diameter of the cover 220 is larger than that of the insertion aperture 100, and is hooked/latched or attached to the upper portion of the insertion aperture 100. Further, the cover 220 may be provided with a pop-up sensor 230 for driving the driving structure 300. The pop-up sensor 230 may be configured to control the pop-up structure 200 to ascend or descend via a force from the driving unit 300 whenever a user touches the pop-up sensor 230. The pop-up sensor 230 may be controlled to operate only when the user touches the pop-up sensor for a predetermined time. This prevents the pop-up structure 200 from operating when the user accidently or unintentionally touches the pop-up sensor 230.

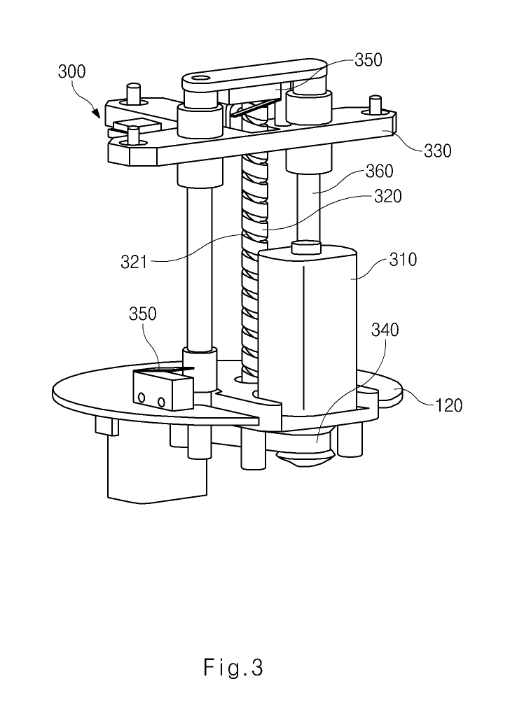

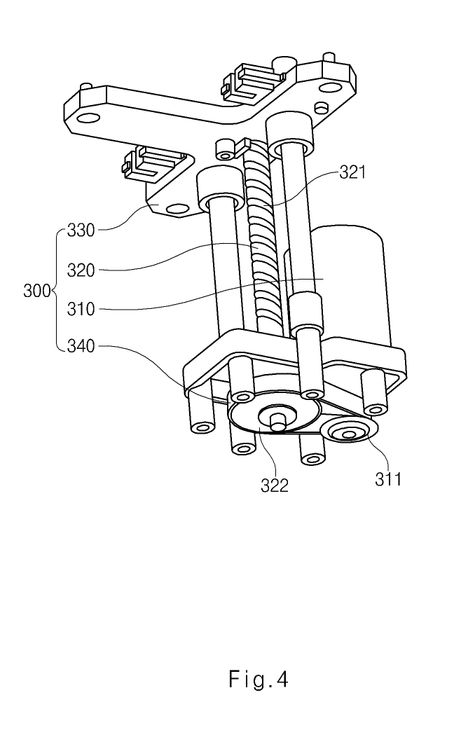

As illustrated in FIGS. 3 and 4, the driving structure 300 includes a motor 310, a screw shaft 320 that is rotated by the motor 310, a moving plate 330 configured to provide a driving force to ascend and descend pop-up structure 200 along the screw shaft 230, a belt, e.g., a timing belt, 340 connecting the motor 310 to the screw shaft 320, and a stop switch 350 configured to stop the driving of the motor 310.

The motor 310 is mounted in a state where the rotating shaft thereof penetrates one side of an upper surface of the base plate 120, and a timing gear 311 is mounted on the rotating shaft of the motor 310. The screw shaft 320 is rotatably mounted on the other side of the upper surface of the base plate 120 in a vertical direction. A spiral groove 321 is formed on the outer periphery of the screw shaft 320, and a moving plate 330 is movably coupled to the spiral groove 321 in the upward and downward directions. On a lower end portion of the screw shaft 320, the timing gear 311 is mounted.

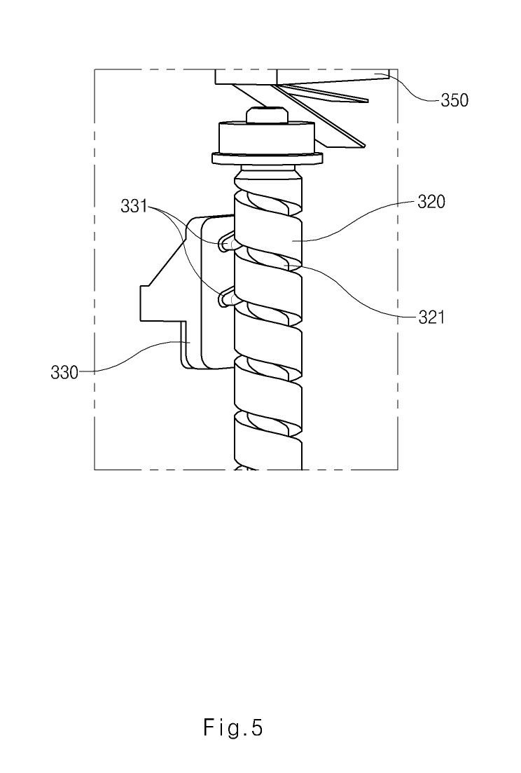

As illustrated in FIG. 5, the moving plate 330 has a through-aperture formed thereon to be penetrated by the screw shaft 320, and a coupling protrusion 331 that is inserted into the spiral groove 321 is formed in the through-aperture. On an upper surface of the moving plate 330, the pop-up structure 200 is mounted. That is, as the coupling protrusion 331 moves along the spiral groove 321 during the rotation of the screw shaft 320, the moving plate 330 ascends upward or descends downward (accordingly), and thus the pop-up structure 200 is drawn out or into of the case 100 accordingly.

The timing belt 340 connects the timing gear 311 of the motor 310 and the timing gear 322 of the screw shaft 320 to each other to transfer the power. That is, the motor 310 and the screw shaft 320 are connected together through the timing belt 340 to accurately transfer the rotational force and reduce noise.

The stop switch 350 limits the range of motion of the moving plate 330. That is, how far up or down the moving plate may ascend or descend. One portion of the stop switch 350 is installed on the upper surface of the moving plate 330 and is pressed when the moving plate 330 descends, and the other portion thereof is installed on the upper surface of the inside of the case 100 and is pressed when the moving plate 330 ascends.

As described above, when the stop switch 350 is pressed by the moving plate 330, the stop switch 350 operates to terminate the rotation of the motor 310, and thus the ascending or descending of the moving plate 330 and the pop-up structure 200 is stopped. Here, the driving structure 300 is provided with the guide bar 360 that guides the moving plate 300 while ascending or descending in the vertical direction along the spiral groove 321 of the screw shaft 320.

At least one guide bar 360 is vertically provided in side the case 100 in the upward and downward directions. The lower end of the guide bar 360 is fixed to the upper surface of the base plate 120, and the upper end thereof is penetratingly inserted into the guide aperture 333 formed on the moving plate 300. That is, when the screw shaft 320 is rotated, the moving plate 330 ascends and is rotated along the spiral groove 321, and at this time, the moving plate 330 ascends or descends along the guide bar 360 so that the moving plate 330 is not rotated by the guide bar 360.

The operation of the pop-up device for a vehicle having the above-described construction according to the exemplary embodiment of the present invention will be described.

First, when the pop-up sensor 230 of the pop-up structure 200 is touched for a predetermined time, the pop-up sensor 230 operates to rotate the motor 310 of the driving structure 300. The timing belt 340 and the screw shaft 320 are rotated in order by the motor 310, and the moving plate 330 ascends along the guide bar 360 by the rotation of the screw shaft 320. As the moving plate 330 ascends, the pop-up structure 200 is drawn out of the case 100. At this time, if the moving plate 330 is positioned on the upper surface of the inside of the case 100, the stop switch 350 is pressed, and the motor 310 is stopped by the stop switch 350.

When the pop-up structure 200 is popped up as described above, sound that is output from the tweeter speaker mounted on the pop-up structure 200 is transferred to the whole interior of the vehicle, and thus the passenger perceive an optimum sound output.

Thereafter, when the pop-up sensor 230 of the pop-up structure 200 is touched again for a predetermined time, the motor 310 of the driving structure 300 is rotated counterclockwise, and as the timing belt 340 is rotated, the screw shaft 320 is rotated counterclockwise. Due to the counterclockwise rotation of the screw shaft 320, the moving plate 330 descends along the guide bar 360, and is drawn into the case 100. At this time, if the moving plate 330 descends down to the upper surface of the base plate 120, the stop switch 350 is pressed, and thus the motor 310 is stopped.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A pop-up device for a vehicle comprising:
a case;
a pop-up structure inserted into an upper portion of the case; and
a driving structure provided inside the case and configured to provide a driving force to the pop-up structure to ascend and descend the pop-up structure in and out of the case,
wherein the driving structure includes a motor, a screw shaft provided in upward and downward directions in the case and having a spiral groove formed along an outer periphery thereof to be rotated by the motor, and a moving plate on which the pop-up structure is mounted, the moving plate movably coupled to the spiral groove formed on the screw shaft in the upward and downward directions to make the pop-up structure ascend or descend when the screw shaft is rotated.

2. The pop-up device for a vehicle according to claim 1, wherein a gear mounted on the motor and a gear mounted on the screw shaft are connected together by a belt to transfer power.

3. The pop-up device for a vehicle according to claim 1, further comprising a guide bar for guiding the moving plate wherein the moving plate performs a rectilinear movement in upward and downward directions.

4. The pop-up device for a vehicle according to claim 1, wherein the case is inserted and mounted in an inner panel of a vehicle.

5. The pop-up device for a vehicle according to claim 1, wherein a base plate for mounting the motor and the screw shaft is provided inside the case.

6. The pop-up device for a vehicle according to claim 1, further comprising a cover structure is formed and configured to hook and fix the cover structure onto an upper portion of the case on the upper end portion of the pop-up structure.

7. The pop-up device for a vehicle according to claim 6, wherein on one side of the cover structure, a pop-up switch for making the pop-up structure ascend or descend through the driving structure is mounted.

8. The pop-up device for a vehicle according to claim 6, wherein the pop-up switch is a sensor which operates when the sensor is touched for a predetermined period of time.

9. The pop-up device for a vehicle according to claim 1, wherein the driving structure further comprises a stop switch that is pressed when the moving plate completely descended to stop the rotation of the motor.

10. The pop-up device for a vehicle according to claim 1, wherein the pop-up structure is provided with a coupling holder for coupling the tweeter speaker thereto.

11. The pop-up device for a vehicle according to claim 1, wherein the pop-up structure is provide with a coupling holder for coupling a portable phone or a portable device thereto.

12. The pop-up device for a vehicle according to claim 1, wherein the moving plate is provided with a coupling protrusion that is formed thereon and is inserted into the spiral groove of the screw shaft to ascend or descend along the spiral groove.

13. A pop-up device for a vehicle comprising:
a case;
a first structure inserted into an upper portion of the case; and
a second structure provided inside the case and configured to provide a driving force to the first structure to ascend and descend the first structure in and out of the case,
wherein the second structure includes a motor, a screw shaft mounted vertically in the case, the screw shaft having a spiral groove formed along an outer periphery thereof to be rotated by the motor, and a plate on which the first structure is mounted, the plate movably coupled to the spiral groove formed on the screw shaft in the upward and downward directions to ascend and descend the first structure.
